(19) United States
(12) Patent Application Publication
(10) Pub. No.: US 2018/0283609 A1
(43) Pub. Date: Oct. 4, 2018

(54) HIGH PRESSURE CONTAINER AND METHOD FOR MANUFACTURING HIGH PRESSURE CONTAINER

(71) Applicants: NITTA CORPORATION, Osaka-shi, Osaka (JP); TOYOTA JIDOSHA KABUSHIKI KAISHA, Toyota-shi, Aichi-ken (JP)

(72) Inventors: Hiromi TERUHIRA, Osaka-shi (JP); Takuji KOMUKAI, Osaka-shi (JP); Maki ONIZUKA, Osaka-shi (JP); Naoki NAKAMURA, Toyota-shi (JP); Masaki ANDO, Toyota-shi (JP)

(73) Assignees: NITTA CORPORATION, Osaka-shi, Osaka (JP); TOYOTA JIDOSHA KABUSHIKI KAISHA, Toyota-shi, Aichi-ken (JP)

(21) Appl. No.: 15/780,879

(22) PCT Filed: Dec. 21, 2016
(86) PCT No.: PCT/JP2016/088163

§ 371 Date: Jun. 1, 2018

(30) Foreign Application Priority Data
Dec. 22, 2015 (JP) 2015-250327

(51) Int. Cl. F17C 1/06; B29C 70/86; B29C 70/32; B29C 70/22

(52) U.S. Cl. CPC F17C 1/06; B29C 70/865; B29C 53/602; B29C 70/228; B29C 70/32

(57) ABSTRACT

A high pressure container has enhanced pressure resistant strength, and a method for manufacturing such high pressure container. The high pressure container includes a sealable hollow liner and a reinforcement layer including a composite carbon fiber bundle covering an outer surface of the hollow liner, wherein the reinforcement layer is wound around the outer surface of the hollow liner and fixed with a cured product of thermosetting resin, and a stress relaxation portion including the cured product of thermosetting product and a plurality of carbon nanotubes between a carbon fiber contained in one composite carbon fiber bundle and a carbon fiber contained in the other composite carbon fiber bundle.

### TECHNICAL FIELD

The present invention relates to a high pressure container, and a method for manufacturing a high pressure container.

### BACKGROUND ART

In recent years, there have been developed vehicles which are driven by combustion energy of fuel gas and electric energy generated by electro-chemical reaction of fuel gas. Fuel gases such as hydrogen gas and natural gas are stored in a high pressure container including a sealable hollow liner at a pressure higher than normal pressure. The outer surface of the hollow liner is coated with a reinforcement layer (fiber reinforced resin layer) which is formed by winding fibers impregnated with resin (for example, Patent Literatures 1 and 2).

Since as the pressure (filling pressure) of the fuel gas to be filled in the high pressure container increases, the filling amount of fuel gas increases, thus increasing the travelable distance of a vehicle, higher filling pressure of fuel gas is more preferable. Further, to increase the filling pressure of fuel gas, the high pressure container is required to have enhanced pressure resistance strength.

### CITATION LIST

### Patent Literature

Patent Literature 1: Japanese Patent Laid-Open No. 2013-173304

Patent Literature 2: Japanese Patent Laid-Open No. 2007-260973

### SUMMARY OF INVENTION

### Technical Problem

To increase the pressure resistance strength of a high pressure container, it is necessary, for example, to increase the amount of fibers contained in the reinforcement layer. Increase in the amount of fibers will cause problems such as increases in the manufacturing cost, mass, and constitution of the high pressure container. For that reason, there is need for increasing the pressure resistance strength of the high pressure container without increasing the amount of fibers constituting the reinforcement layer.

Accordingly, it is an object of the present invention to provide a high pressure container having enhanced pressure resistance strength, and a method for manufacturing such high pressure container.

### Solution to Problem

A high pressure container according to the present invention comprises: a hollow liner capable of being sealed; and a reinforcement layer covering an outer surface of the hollow liner, wherein the reinforcement layer includes composite carbon fiber bundles laminated in multiple layers, and the composite carbon fiber bundles are wound around the outer surface of the hollow liner and fixed by a cured product of thermosetting resin, and the reinforcement layer contains a stress relaxation portion which includes the cured product of thermosetting resin and a plurality of carbon nanotubes between a carbon fiber contained in one composite carbon fiber bundle and a carbon fiber contained in other of the composite carbon fiber bundles.

A method for manufacturing a high pressure container according to the present invention is a method for manufacturing a high pressure container having a reinforcement layer on an outer surface of a hollow liner capable of being sealed, the method comprising steps of: winding a composite carbon fiber bundle impregnated with a thermosetting resin around the outer surface of the hollow liner while applying a tensile load to the composite carbon fiber bundle, and forming the reinforcement layer by curing the thermosetting resin, wherein the composite carbon fiber bundle contains a plurality of continuous carbon fibers, on each of whose surfaces a structure containing a plurality of carbon nanotubes is formed, and the structure is directly adhered to a surface of each of the plurality of continuous carbon fibers.

### Advantageous Effects of Invention

According to the present invention, a high pressure container comprises a reinforcement layer containing multiple layers of composite carbon fiber bundles fixed with a cured product of thermosetting resin. Since a stress relaxation portion containing a cured product of thermosetting resin is formed between a carbon fiber contained in one composite carbon fiber bundle and a carbon fiber contained in the other composite carbon fiber bundle, toughness of the high pressure container will increase. As a result of that, a reinforcement layer having enhanced strength is formed, and thereby a high pressure container having enhanced pressure resistance strength is obtained.

What is used for manufacturing the reinforcement layer in the method for manufacturing a high pressure container according to the present invention is a composite carbon fiber bundle which contains a plurality of continuous carbon fibers to whose surfaces a plurality of carbon nanotubes (hereinafter, referred to as CNTs) are adhered. Since impregnating the composite carbon fiber bundle with a thermosetting resin, and winding it around the outer surface of the hollow liner while applying a tensile load to the composite carbon fiber bundle form a stress relaxation portion between the composite carbon fiber bundles, a reinforcement layer having enhanced pressure resistance strength will be obtained. Thus, it is possible to manufacture a high pressure container having enhanced pressure resistance strength.

### BRIEF DESCRIPTION OF DRAWINGS

FIG. 1 is a perspective view showing a high pressure container according to the present embodiment;

FIG. 2 is a partial sectional view in the longitudinal direction of the high pressure container according to the present embodiment;

FIG. 3 is an enlarged view of a region X in FIG. 2;

FIG. 4 is a schematic diagram to illustrate a composite carbon fiber bundle constituting a reinforcement layer, in which FIG. 4A is a general view, and FIG. 4B is an enlarged view;

FIG. 5 is a schematic diagram to illustrate a joined state of carbon fibers at an interface between composite carbon fiber bundles;

FIG. 6 is a schematic plan view of a filament winding apparatus;

FIG. 7 is schematic side view of the filament winding apparatus shown in FIG. 6;

FIG. 8 is a photograph to show a high pressure container which is cut to observe the cross section of the reinforcement layer after internal pressure breakage test, in which FIG. 8A is a general image, and FIG. 8B is an enlarged image of the cut part;

FIG. 9 is a schematic diagram showing laminated composite carbon fiber bundles contained in a cut piece of the reinforcement layer;

FIG. 10 is a microscopic photograph showing a cross section of a reinforcement layer sample, in which FIG. 10A is a general image, and FIG. 10B is an enlarged image of a region Y1 in FIG. 10A; and

FIG. 11 is a scanning electron microscope (SEM) image of a region Y2 in FIG. 10B, in which FIG. 11A is a general image, and FIG. 11B is an enlarged image.

### DESCRIPTION OF EMBODIMENTS

Hereafter, an embodiment of the present invention will be described in detail with reference to the drawings.

### 1. GENERAL CONFIGURATION

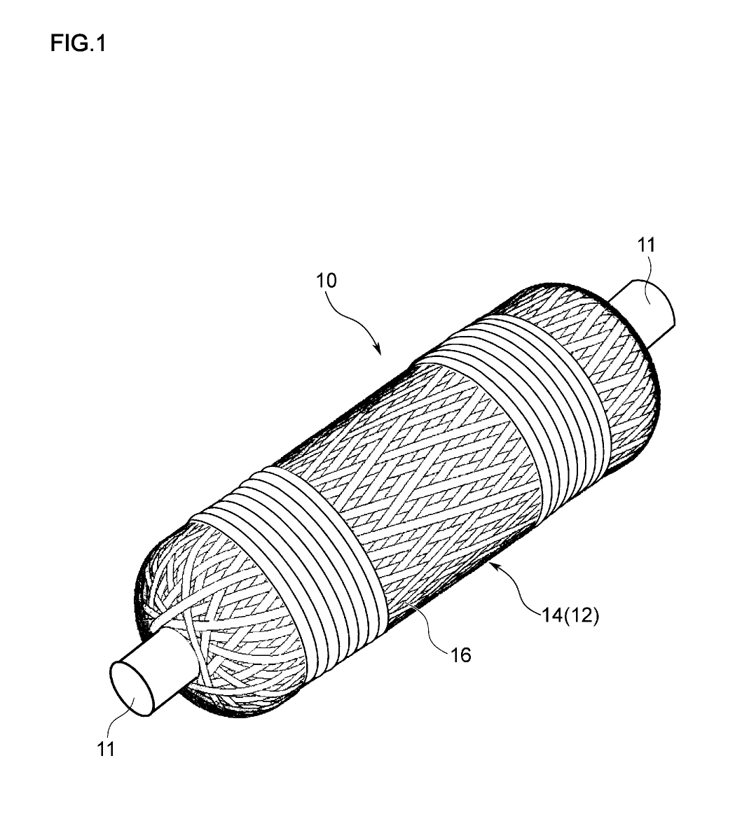

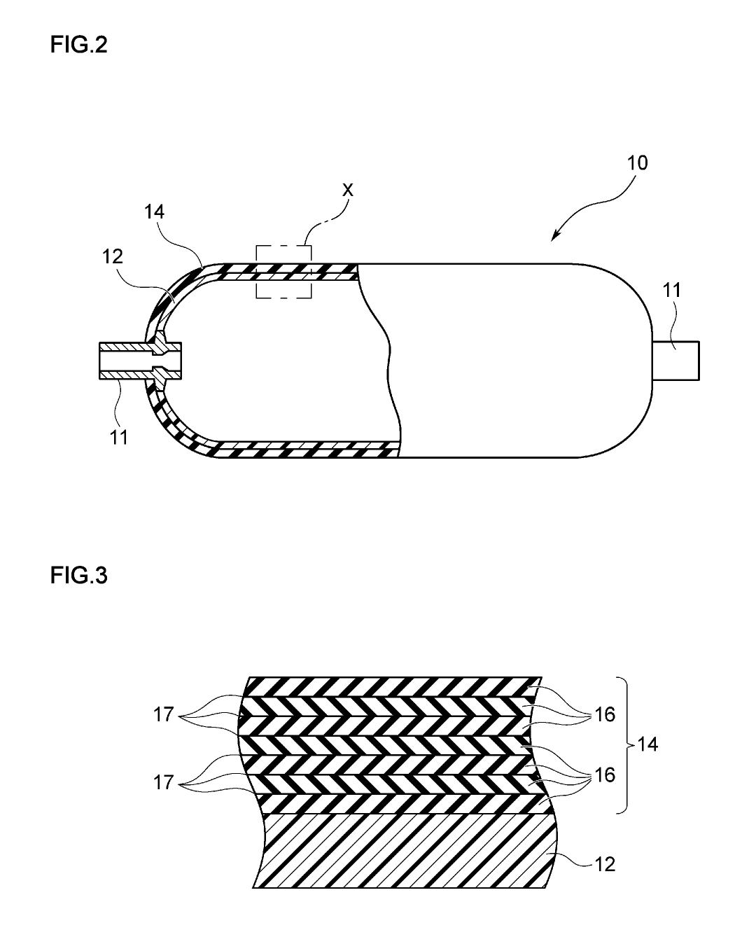

As shown in FIGS. 1 and 2, a high pressure container 10 of the present embodiment includes a sealable hollow liner 12, and a reinforcement layer 14 which covers an outer surface of the hollow liner 12. In the case of the present embodiment, the hollow liner 12 includes a cylinder portion having a substantially cylindrical shape, and a convex spherical portion provided at each end of the cylinder portion. The convex spherical portion at each end is composed of an isotonic curve. At each apex of convex spherical portion, a metal mouthpiece 11 for connecting the high pressure container 10 to an external piping, etc. (not shown) is provided, respectively. In the present embodiment, a resin-made vessel dominantly composed of nylon is used as the hollow liner 12. The mouthpiece 11 of the hollow liner 12 is made of aluminum. The hollow liner 12 and the mouthpiece 11 are connected in a sealed manner by means of a rubber gasket not shown.

The reinforcement layer 14 includes composite carbon fiber bundles 16 wound around the outer surface of the hollow liner 12. Composite carbon fiber bundles 16 are wound around the hollow liner 12 in such a way that longitudinal directions of the composite carbon fiber bundles 16 differ from each other. The composite carbon fiber bundles 16 are wound around the outer surface of the hollow liner 12 by means of helical winding in which the bundle is wound in an oblique direction with respect to the cylinder portion of the hollow liner 12, and hoop winding in which the bundle is wound in a normal direction with respect to an axis of the cylinder portion of the hollow liner 12.

In a region X in FIG. 2, the reinforcement layer 14 is composed of composite carbon fiber bundles 16 laminated in multiple layers via an interface 17. As shown in FIG. 3, in the present embodiment, the reinforcement layer 14 includes composite carbon fiber bundles 16 laminated in seven layers. The plurality of laminated composite carbon fiber bundles 16 are fixed with a cured product of thermosetting resin which is not shown. In the case of the present embodiment, the plurality of laminated composite carbon fiber bundles 16 are fixed with a cured product of epoxy resin as the thermosetting resin. The composite carbon fiber bundles 16 may be used as a secondary fiber bundle in which a plurality of bundles (for example, four bundles) are bundled into one bundle.

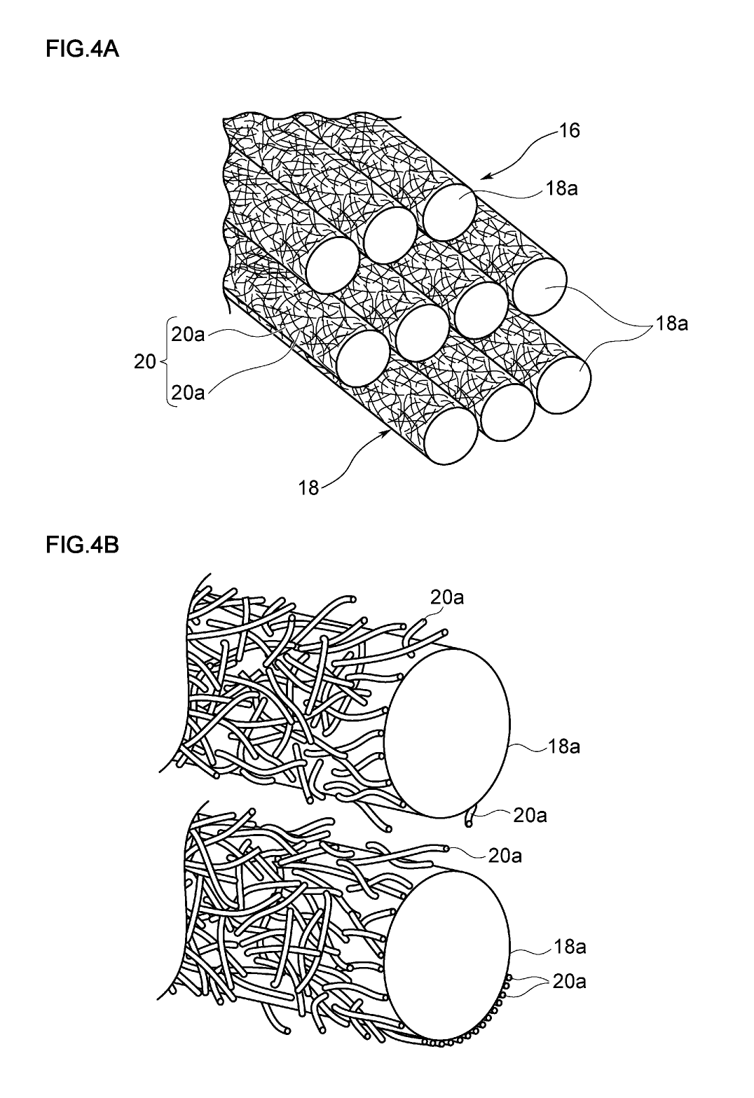

Each of the plurality of composite carbon fiber bundles 16 includes a plurality of continuous composite carbon fibers 18 as shown in FIG. 4A. Since the plurality of laminated composite carbon fiber bundles 16 are fixed to each other by a cured product of thermosetting resin as described above, the plurality of composite carbon fibers 18 contained in each composite carbon fiber bundle 16 are also fixed to each other by the cured product of thermosetting resin. The composite carbon fiber 18 is composed of continuous carbon fibers 108a and a plurality of CNTs 20a which are adhered to surfaces of the carbon fibers 18a. As shown in FIG. 4B, although the CNTs 20a are basically in close contact with the surface of the carbon fiber 18a, there are also CNTs 20a which adheres to the surface of the carbon fiber 18a in a state of being partly floated from the surface of the carbon fiber 18a. It is noted that in FIG. 4B, to facilitate understanding of the state of CNTs 20a, the distance between carbon fibers 18a is shown in exaggeration. The carbon fiber 18a to which CNTs 20a are adhered will be described later in detail.

Although the composite carbon fiber bundle 16 is shown to have 10 continuous composite carbon fibers 18 for illustrative purpose, the composite carbon fiber bundle 16 in the present embodiment is composed of ten thousand to thirty thousand continuous composite carbon fibers 18. The plurality of continuous composite carbon fibers 18 are arranged in one direction maintaining linearity substantially without being entangled with each other, thus constituting a composite carbon fiber bundle 16.

The entanglement of the composite carbon fibers 18 in the composite carbon fiber bundle 16 can be evaluated by the degree of disarrangement of the composite carbon fibers 18. For example, a composite carbon fiber bundle 16 is observed by SEM at a fixed magnification, and lengths of predetermined number (for example, ten) of composite carbon fibers 18 contained therein are measured. It is possible to evaluate the degree of disarrangement of the composite carbon fiber 18 based on variation, difference between the minimum and maximum values, and standard deviation of length for a predetermined number of composite carbon fibers 18.

It is also possible to determine that the plurality of composite carbon fibers 18 are not substantially entangled by measuring the degree of entanglement, for example, in accordance with the degree of entanglement measurement method of JIS L1013: 2010 “Test method of chemical fiber filament yarn”. A smaller value of measured degree of entanglement means that there is less entanglement between composite carbon fibers 18 in the composite carbon fiber bundle 16. In a composite carbon fiber bundle 16, as a result of the plurality of composite carbon fibers 18 being substantially not entangled with each other, each of composite carbon fibers 18 can contribute to the strength thereof.

As described above, each of the plurality of continuous composite carbon fibers 18 is composed of a continuous carbon fiber 18a, and the plurality of CNTs 20a adhered to the surface of the carbon fiber 18a. The carbon fiber 18a is a fiber having a diameter of 5 to 20 μm. Generally, the carbon fiber 18a is obtained by firing of organic fibers derived from petrol, coal, and coal tar, such as polyacrylonitrile, rayon, and pitch, and organic fibers derived from woods and plants.

The CNT 20a is directly adhered to the surface of the carbon fiber 18a. The term “adhesion” herein means bonding by van der Waals force. The plurality of CNTs 20a adhered to the surface of the carbon fiber 18a are uniformly dispersed and entangled with each other on substantially the entire surface of the carbon fiber 18a. The plurality of CNTs 20a can form a structure 20 having a network structure on the surface of the carbon fiber 18a by being brought into direct contact or direct connection with each other. It is preferable that there is neither dispersing agent such as surfactants, nor intervening material such as adhesives between the CNTs 20a.

The term “connection” herein includes physical connection (mere contact). Further, “direct contact or direct connection” includes a state in which a plurality of CNTs are merely in contact with each other, as well as a state in which a plurality of CNTs are integrally connected, and should not be construed in a limited fashion.

The length of the CNT 20a is preferably 0.1 to 50 μm. When the length of the CNT 20a is not less than 0.1 μm, CNTs 20a will be entangled with each other, thereby being directly connected. Further, when the length of the CNT 20a is not more than 50 μm, the CNTs 20a are more likely to be uniformly dispersed. On the other hand, when the length of the CNT 20a is less than 0.1 μm, CNTs 20a become less likely to be entangled with each other. Moreover, when the length of CNT 20a is more than 50 μm, the CNTs become more likely to aggregate.

The CNT 20a preferably has an average diameter of not more than about 30 nm. When CNT 20a has a diameter not more than 30 nm, it has excellent flexibility and is able to successfully form a network structure on the surface of each carbon fiber 18a. On the other hand, when the diameter of the CNT 20a is more than 30 nm, it loses flexibility and becomes less likely to form a network structure on the surface of each carbon fiber 18a. It is noted that the diameter of the CNT 20a is supposed to be an average diameter measured by using transmission electron microscope (TEM) photograph. The CNT 20a more preferably has an average diameter of not more than about 20 nm.

The plurality of CNTs 20a preferably are uniformly adhered to each surface of the plurality of continuous carbon fibers 18a. The adhering state of the CNT 20a on the surface of carbon fiber 18a can be observed by SEM, and the obtained image can be visually evaluated.

In the composite carbon fiber bundle 16, the plurality of CNTs 20a are uniformly adhered to the surfaces of the plurality of continuous carbon fibers 18a. Therefore, any carbon fiber to whose surface CNT aggregates are adhered is substantially not contained in the composite carbon fiber bundle 16. Any carbon fiber to whose surface insufficient amount of CNTs are adhered is substantially not present in the composite carbon fiber bundle 16.

In a composite carbon fiber bundle 16, a CNT 20a is directly adhered to the surface of a carbon fiber 18a. That is, the CNT 20a is directly adhered to the surface of the carbon fiber 18a without a dispersing agent such as surfactants and adhesives interposed between itself and the surface of the carbon fiber 18a. Although not explicitly shown in FIG. 4A, each of the plurality of continuous carbon fibers 18a contained in the composite carbon fiber bundle 16 is in contact with another carbon fiber 18a via a cured product of thermosetting resin not shown and the plurality of CNTs 20a. In the present description, a cured product of thermosetting resin containing the plurality of CNTs 20a adhered to the carbon fiber 18a is referred to as a stress relaxation portion.

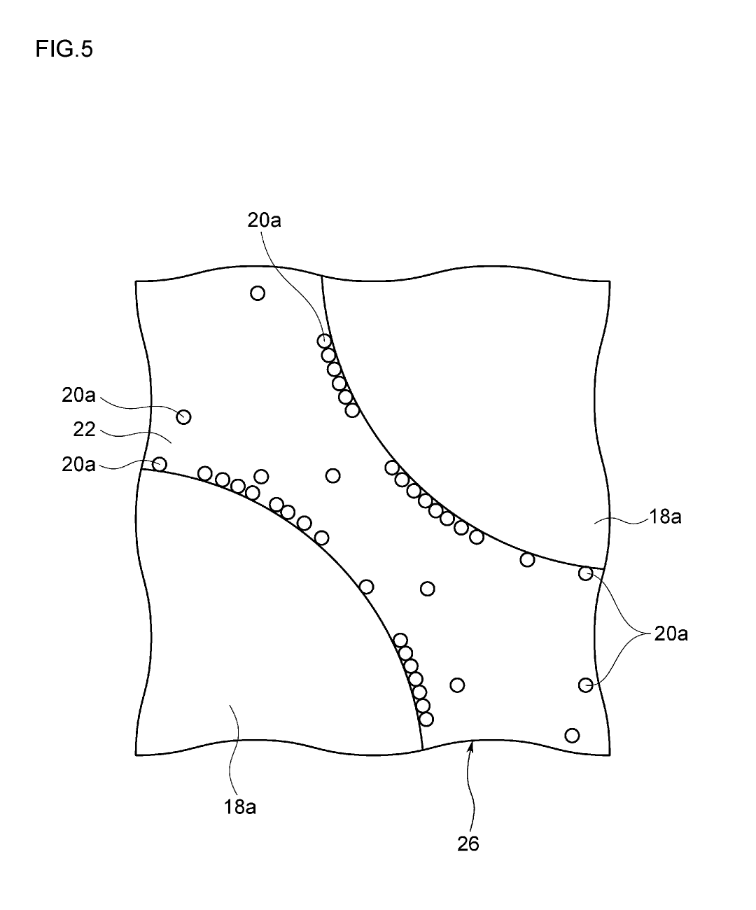

In FIG. 5 which schematically represents an interface 17 of composite carbon fiber bundles 16, carbon fibers 18a which are in contact with each other via a stress relaxation portion 26 are shown. There is the stress relaxation portion 26 containing the cured product 22 of thermosetting resin between a carbon fiber 18a contained in one composite carbon fiber bundle 16 and a carbon fiber 18a contained in the other composite carbon fiber bundle 16. A plurality of CNTs 20a are contained in the stress relaxation portion 26. Some of the plurality of CNTs 20a are directly adhered to the surface of each carbon fiber 18a as described above. A part in one CNT 20a may adhere to the surface of a carbon fiber 18a.

### 2. MANUFACTURING METHOD

Next, a method for manufacturing a high pressure container 10 according to the present embodiment will be described. The high pressure container 10 can be manufactured by winding a composite carbon fiber bundle 16 impregnated with a thermosetting resin around the outer surface of a sealable hollow liner 12 and curing the thermosetting resin. “Impregnation” means causing the thermosetting resin to infiltrate into gaps between composite carbon fiber bundles 16. The composite carbon fiber bundle 16 can be manufactured by immersing a carbon fiber bundle containing a plurality of continuous carbon fibers 18a into a CNT-isolated dispersion (hereinafter, also referred to simply as a dispersion) in which CNTs 20a are isolated and dispersed, and applying ultrasonic vibration of a predetermined frequency thereto to cause the CNTs 20a to adhere to the surface of each of the carbon fibers 18a, thus forming a structure 20.

Hereinafter, each process of preparing a dispersion for producing the composite carbon fiber bundle 16, producing the composite carbon fiber bundle 16, and forming a reinforcement layer 14 by using the composite carbon fiber bundle 16 will be described in detail in order.

<Preparation of Dispersion>

For the preparation of a dispersion, it is possible to use a CNT 20a which is manufactured in the following manner. The CNT 20a can be manufactured by forming a catalyst film composed of aluminum and iron on a silicon substrate by using a thermal CVD method as described in, for example, Japanese Patent Laid Open No. 2007-126311, processing catalyst metal for growing the CNT into minute particles, and bringing hydrocarbon gas into contact with the catalyst metal in a heating atmosphere. Although it is also possible to use CNTs which are obtained by another manufacturing method such as an arc discharge method and a laser evaporation method, it is preferable to use a CNT which contains as little impurities as possible. These impurities may be removed by high-temperature annealing in an inert gas after the CNT is manufactured. The CNT manufactured by this manufacturing example is a long-sized CNT which is linearly oriented with a high aspect ratio of a diameter of not more than 30 nm and a length of several hundred μm to several mm. Although the CNT may either be single layered or multiple layered, it is preferably a multi-layered CNT.

Next, by using the manufactured CNT 20a described above, a dispersion in which CNTs 20 are isolated and dispersed is manufactured. Isolated dispersion means a state in which CNTs 20a are dispersed in a dispersion medium with each one of the CNTs 20a being physically isolated without being entangled. Specifically, isolated dispersion means a state in which a fraction of an assembly in which two or more CNTs 20a are assembled in a bundled form is not more than 10%.

The CNT 20a produced as described above is added to a dispersion medium, and the dispersion is subjected to uniformization of the dispersion of CNTs 20a by a homogenizer, shearing machine, ultrasonic disperser, etc. As the dispersion medium, water, alcohols such as ethanol, methanol and isopropyl alcohol, and organic solvents such as toluene, acetone, tetrahydrofuran (THF), methyl ethyl ketone (MEK), hexane, normal hexane, ethyl ether, xylene, methyl acetate and ethyl acetate can be used. Although additives such as dispersing agents and surfactants are not necessarily required for the preparation of the dispersion, such additives may be used provided that their contents are within a range not limiting the functions of the carbon fiber 18a and the CNT 20a.

<Production of Composite Carbon Fiber Bundle>

A carbon fiber bundle containing a plurality of continuous carbon fibers 18a and being immersed in the dispersion produced as described above is applied with ultrasonic vibration of a frequency of more than 40 kHz and not more than 180 kHz. Application of ultrasonic vibration causes a plurality of CNTs 20a to directly adhere to the surface of each carbon fiber 18a in the carbon fiber bundle. The CNTs 20a which are adhered to the surface of each carbon fiber 18a are directly connected with each other to form a network structure so that a structure 20 is formed on the surface of each carbon fiber 18a.

When the frequency is more than 40 kHz, entanglement between carbon fibers 18a in a carbon fiber bundle is suppressed. Moreover, when the frequency is not more than 180 kHz, CNTs 20a successfully adhere to the surface of each carbon fiber 18a. On the other hand, when the frequency is not more than 40 kHz, entanglement between carbon fibers 18a becomes evident. Moreover, when the frequency is more than 180 kHz, the adhesion state of CNTs 20a on the surface of the carbon fiber 18a deteriorates, thus disabling the formation of the structure 20. To further reduce entanglement of carbon fibers 18a, the frequency of ultrasound is preferably not less than 100 kHz, and more preferably not less than 130 kHz.

Applying ultrasonic vibration of a frequency of more than 40 kHz and not more than 180 kHz to the dispersion creates a reversible reaction state in the dispersion, in which a dispersed state and aggregated state of CNTs 20a occur continuously.

A carbon fiber bundle containing a plurality of continuous carbon fibers 18a is immersed in a dispersion in such a reversible reaction state. Then, a reversible reaction state between a dispersion state and an aggregation state occurs even on the surface of each carbon fiber 18a, and CNTs 20a adhere to the surface of each carbon fiber 18a during transition from the dispersion state to the aggregation state.

During aggregation, the CNTs 20a are subject to van der Waals force, and this van der Waals force causes the CNTs 20a to adhere to the surface of the carbon fiber 18a, thereby forming a composite carbon fiber 18. Thereafter, by pulling out a bundle of composite carbon fibers 18 from the dispersion and drying it, it is possible to obtain a composite carbon fiber bundle 16 in which a structure 20 having a network structure is formed on the surface of each of the carbon fibers 18a. Drying can be achieved by placing the bundle of composite carbon fibers on, for example, a hot plate.

In the composite carbon fiber bundle 16, there is substantially no entanglement between carbon fibers 18a. CNTs 20a well adhere to the surface of each carbon fiber 18a in the composite carbon fiber bundle 16, thus forming a structure 20.

Because the plurality of composite carbon fibers 18 are not substantially entangled with each other, there is little risk that strength thereof declines caused by the entanglement between the carbon fibers 18a even when the composite carbon fiber bundle 16 is impregnated with a thermosetting resin. Since CNTs 20a are well adhered to the surface of each carbon fiber 18a forming the structure 20, it is possible to firmly bond the carbon fibers 18a with each other by curing the thermosetting resin, and make them exert high strength.

<Formation of Reinforcement Layer>

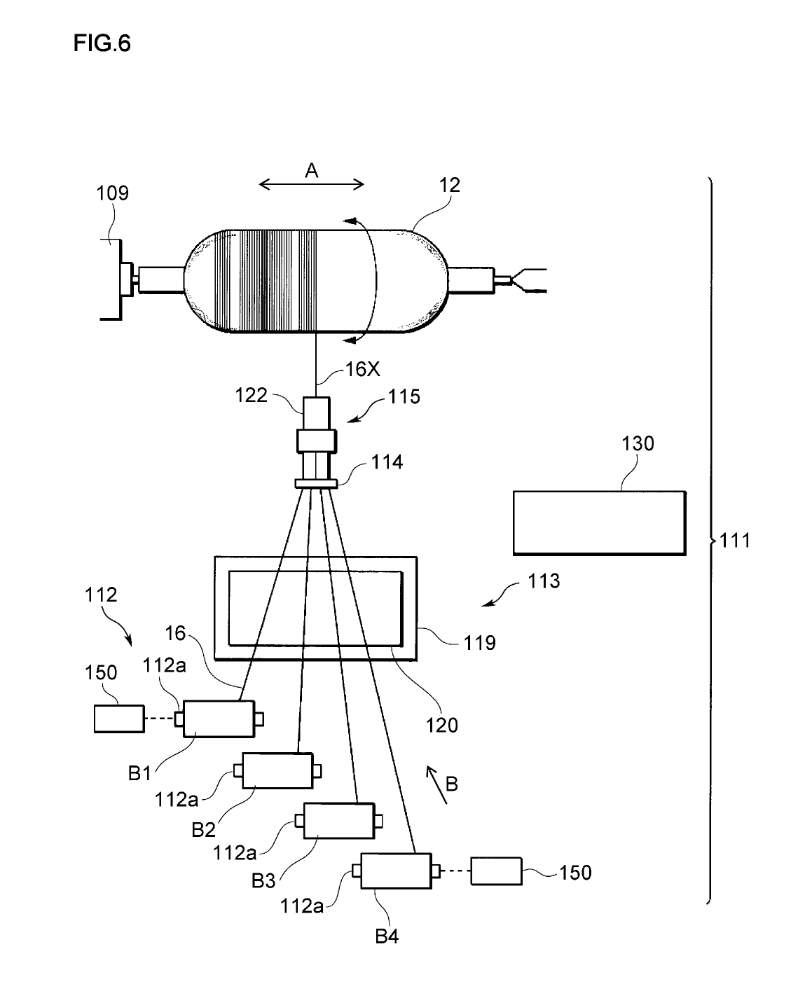

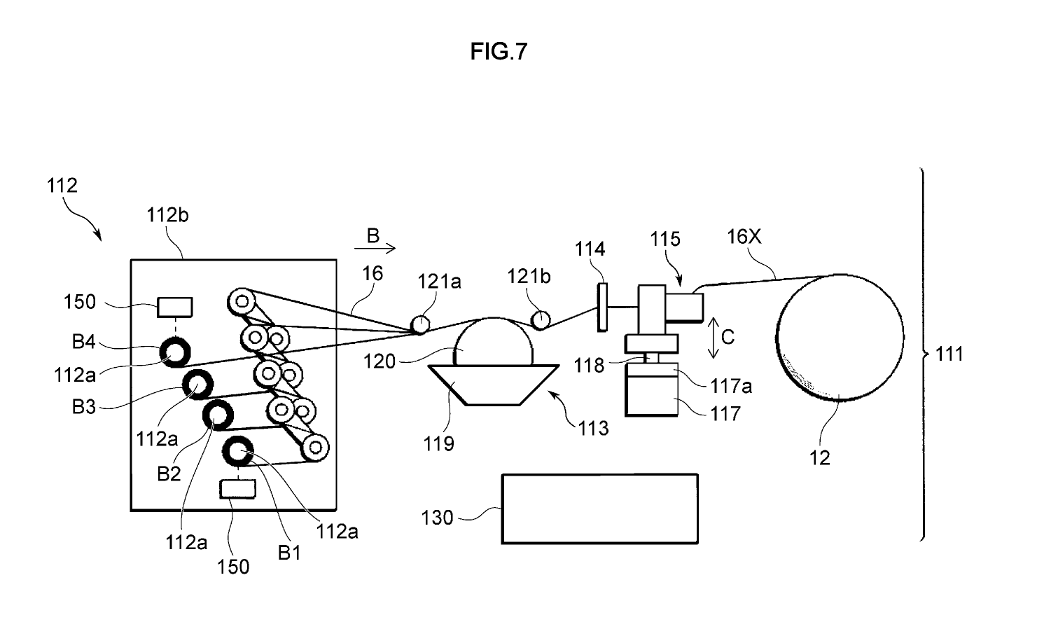

The reinforcement layer 14 can be formed on the outer surface of the hollow liner 12 through a filament winding method (hereinafter, referred to as a “FW method”) by using the composite carbon fiber bundle 16 produced as described above. When forming the reinforcement layer 14 by the FW method, it is possible to use, for example, a filament winding apparatus (hereinafter, referred to as a “FW apparatus”) 111 as shown in FIGS. 6 and 7.

The FW apparatus 111 includes a composite carbon fiber bundle supply portion (composite fiber bundle supply means) 112, a resin impregnation apparatus 113, a composite carbon fiber bundle guide 114, and a yarn supply unit 115. The FW apparatus 111 is an apparatus of a wet method since it includes a resin impregnation apparatus 113 for impregnating the composite carbon fiber bundle 16 with a molten resin. A chuck 109 can rotatably support a sealable hollow liner 12. The yarn supply unit 115 provided in an attachment portion 122 is reciprocatingly movable along a longitudinal direction of the hollow liner 12 (arrow A direction in FIG. 6).

As shown in FIG. 7, the yarn supply unit 115 is attached to a second actuator 118 supported by a first actuator 117. The second actuator 118 is supported by the first actuator 117 via a moving body 117a. The first actuator 117 is a known configuration which employs a ball screw (not shown) to move a moving body 117a, which is movable integrally with a nut (not shown), in one axis direction. The yarn supply unit 115, which is reciprocatingly movable in a direction perpendicular to the page face (arrow A direction in FIG. 6) by the action of the first actuator 117, can move up and down in an arrow C direction in FIG. 7 by the action of second actuator 118 on the moving body 117a.

The FW apparatus 111 shown includes 4 bobbins B1 to B4 wound with composite carbon fiber bundles 16 in the composite carbon fiber bundle supply portion 112. Each of the bobbins B1 to B4 is supported by a support shaft 112a connected to a creel stand 112b. As the creel stand 112b, for example, Powder Brake, and so-called Perma-Torque which is configured to apply load to a spindle 112a by eddy current can be used.

The resin impregnation apparatus 113 includes a resin bath 119 for accommodating a thermosetting resin in a molten state, and an impregnation roller 120 which is immersed in the thermosetting resin in the resin bath 119. The impregnation roller 120 rotates in the thermosetting resin in a molten state to supply thermosetting resin in a molten state to the composite carbon fiber bundle 16. Above the resin bath 119, feed rolls 121a and 121b are disposed.

A feed roll 121a feeds the composite carbon fiber bundle 16 pulled out in the arrow B direction from the bobbins B1 to B4, and guides it to a predetermined position of a resin bath 119. Between the composite carbon fiber bundle supply portion 112 and the feed roll 121a, a tension roller (not shown) is provided in correspondence to each of the composite carbon fiber bundles 16 pulled out from the bobbins B1 to B4.

The composite carbon fiber bundle 16 guided by the feed roll 121a is pressed against the surface of the impregnation roller 120. Since the thermosetting resin in a molten state is adhered to the surface of the impregnation roller 120, as a result of the composite carbon fiber bundle 16 passing through the resin impregnation apparatus 113, the thermosetting resin in a molten state is impregnated into the composite carbon fiber bundle 16.

The feed roll 121b guides the composite carbon fiber bundle 16 after being impregnated with the thermosetting resin in a molten state in the resin impregnation apparatus 113, to the composite carbon fiber bundle guide 114. The composite carbon fiber bundle guide 114 guides the plurality of composite carbon fiber bundles 16, which have been impregnated with a thermosetting resin in a molten state, to the yarn supply unit 115. The yarn supply unit 115 bundles the plurality of composite carbon fiber bundles 16 guided from the composite carbon fiber bundle guide 114 into line and supplies them to the hollow liner 12 as a secondary fiber bundle 16X.

A chuck 109 rotatably supports the hollow liner 12 centering around an axis of the hollow liner 12. The chuck 109 that supports the hollow liner 12 is driven to rotate by a variable speed motor not shown. The variable speed motor is controlled by a control section (abnormality detection section) 130. The chuck 109 is driven to rotate in synchronous with the moving speed of the yarn supply unit 115. As a result of this, it is possible to wind the composite carbon fiber bundle 16 around the hollow liner 12 while arbitrarily setting a winding angle of the secondary fiber bundle 16X with respect to the hollow liner 12.

A rotational speed detector (speed detection means) 150 for detecting the rotational speed of each bobbin B1, B4 is provided in the bobbins B1 and B4 which are located at both ends in a plan view. The rotational speed detector 150 is provided on the support shaft 112a of each bobbin B1, B4 and successively detects the rotational speeds of the bobbins B1 and B4. The detection output of the rotational speed detector 150 is provided to the control section 130.

Although, in the present embodiment, the rotational speed detector 150 is provided in the bobbins B1 and B4 which supply the composite carbon fiber bundles 16 located at both ends in the width direction of the composite carbon fiber bundle 16, among the bobbins B1 to B4 which are provided in multiple numbers, the rotational speed detector 150 may be provided in all of the bobbins B1 to B4.

Actions of the FW apparatus 111 configured as described above will be described below. The yarn supply unit 115 is fixed to the second actuator 118 in the attachment portion 122 and is attached to the FW apparatus 111. When forming the reinforcement layer 14 on the outer surface of the hollow liner 12 to manufacture a high pressure container, first, the hollow liner 12 is supported by the chuck 109 of the FW apparatus 111.

Next, the yarn supply unit 115 is disposed at an original position (winding start position) by adjusting a position of the hollow liner 12 in a longitudinal direction (arrow A direction in FIG. 6) and a position of the hollow liner 12 in a diametrical direction (arrow C direction in FIG. 7). The position of the yarn supply unit 115 in the longitudinal direction of the hollow liner 12 can be adjusted by actuating the first actuator 117. The position of the yarn supply unit 115 in the diametrical direction of the hollow liner 12 can be adjusted by actuating the second actuator 118.

The plurality of composite carbon fiber bundles 16 are spun out from the composite carbon fiber bundle supply portion 112 in the arrow B direction, and is guided to the yarn supply unit 115 via the resin impregnation apparatus 113 and the fiber bundle guide 114. The composite carbon fiber bundles 16 impregnated with the thermosetting resin are bundled into line to form a secondary fiber bundle 16X. An end part of the secondary fiber bundle 16X is fixed to a predetermined position of the hollow liner 12. The end part of the secondary fiber bundle 16X can be manually fixed by a worker using, for example, adhesive tape.

The length, diameter, and rotational speed of the hollow liner 12, and winding conditions such as a winding width when the secondary fiber bundle 16X is wound around the hollow liner 12 are inputted to the control section 130.

Next, winding operation of the secondary fiber bundle 16X by the FW apparatus 111 is started. When the operation of the FW apparatus 111 is started, the hollow liner 12 is rotated in a fixed direction. At the same time, the first actuator 117 in the yarn supply unit 115 is driven. The yarn supply unit 115 can move along with the moving body 117a from the starting position of winding in parallel with the longitudinal direction of the hollow liner 12. The plurality of composite carbon fiber bundles 16 are successively drawn out from the composite carbon fiber bundle supply portion 112.

The plurality of composite carbon fiber bundles 16 are impregnated with a thermosetting resin in a molten state in the resin impregnation apparatus 113. Thereafter, the plurality of composite carbon fiber bundles 16 which have been impregnated with the thermosetting resin are bundled into line in the yarn supply unit 115, and are wound around the surface to be wound of the hollow liner 12 as the secondary fiber bundle 16X while being applied with a tensile load. The magnitude of the tensile load may be appropriately set considering winding conditions.

The secondary fiber bundle 16X can be wound around the outer surface of the hollow liner 12 so as to obtain a layer of arbitrary thickness by any winding method. The winding method of the secondary fiber bundle 16X and the thickness of the layer after winding can be set by adjusting the moving speed of the moving body 117a and the rotational speed of the hollow liner 12. The winding method of the secondary fiber bundle 16X can be selected from, for example, helical winding and hoop winding. After the secondary fiber bundle 16X is wound around the outer surface of the hollow liner 12 in a predetermined thickness, an end part of the secondary fiber bundle 16X is fixed to the hollow liner 12, and a part of the secondary fiber bundle 16X extending from the fixing part to an exit guide (not shown) is cut.

Next, the hollow liner 12 is taken out from the chuck 109 and is placed in a heating furnace to be heated at a predetermined temperature. By curing the thermosetting resin, the composite carbon fiber bundles 16 wound around the outer surface of the hollow liner 12 are fixed, thus forming a reinforcement layer 14.

As described so far, a high pressure container 10 of the present embodiment is obtained in which the outer surface of the hollow liner 12 is covered by the reinforcement layer 14. The reinforcement layer 14 is formed of the wound composite carbon fiber bundles 16.

### 3. FUNCTIONS AND EFFECTS

The high pressure container 10 according to the present embodiment is reinforced by the reinforcement layer 14 containing composite carbon fiber bundles 16 which are wound around the outer surface of the hollow liner 12 and fixed by a cured product 22 of thermosetting resin. The composite carbon fiber bundle 16 includes a plurality of carbon fibers 18a to whose surfaces a plurality of CNTs 20a are adhered. The carbon fibers 18a are in contact with each other via the cured product 22 of thermosetting resin in which CNTs 20a are dispersed, that is, a stress relaxation portion 26. The stress relaxation portion 26 is also present between a carbon fiber 18a contained in one composite carbon fiber bundle 16 and a carbon fiber 18a contained in the other composite carbon fiber bundle 16.

In general, since the elasticity of carbon fiber is higher than the elasticity of the cured product of thermosetting resin, stress concentration occurs at an interface between the carbon fiber and the cured product of thermosetting resin due to the difference in elasticity. The load in this situation is to be preferentially born by the carbon fibers.

In contrast to this, in the present embodiment, a stress relaxation portion 26 in which CNTs 20a are compounded with a cured product 22 of thermosetting resin is formed between the carbon fibers 18a. The elasticity of the stress relaxation portion 26 becomes higher than that of the cured product 22 of thermosetting resin. Even if there is difference in elasticity between the carbon fiber 18a and the cured product 22 of thermosetting resin, the interposition of the stress relaxation portion 26 suppresses abrupt elasticity change, thus relaxing stress concentration. As a result of reduction of stress generated in the carbon fiber 18a, the toughness as the composite carbon fiber bundle 16 is improved, thereby increasing pressure resistance strength.

Since a plurality of CNTs 20a are adhered to the surface of each of the plurality of carbon fibers 18a, adhesive force between the carbon fiber 18a and the cured product 22 of thermosetting resin is enhanced due to anchor effects. As a result of that, peeling strength of the interface between the carbon fiber 18a and the cured product 22 of thermosetting resin increases.

In the present embodiment, presence of CNTs 20a between the carbon fiber 18a and the cured product 22 of thermosetting resin causes the carbon fibers 18a, and further the composite carbon fiber bundles 16 to be firmly adhered to each other. As described above, the stress relaxation portion 26 is present between a carbon fiber 18a contained in one composite carbon fiber bundle 16 and a carbon fiber 18a contained in the other composite carbon fiber bundle 16. By using such composite carbon fiber bundle 16, it is possible to configure a reinforcement layer 14 excellent in pressure resistance, and to manufacture a high pressure container 10 having enhanced pressure resistance strength.

In forming the reinforcement layer 14, the carbon fibers 18a constituting the composite carbon fiber bundle 16 are oriented in a fixed direction to wind the composite carbon fiber bundle 16 around the outer surface of the hollow liner 12 while applying a tensile load to the composite carbon fiber bundle 16. By applying a tensile load to the composite carbon fiber bundle 16, excessive thermosetting resin between carbon fibers 18a will be pushed out. As result of improvement in the uniformity of carbon fiber 18a in the composite carbon fiber bundle 16 will reduce variation of the fraction (Vf) of the composite carbon fiber bundle 16 in the reinforcement layer 14, thus improving the uniformity of the composite carbon fiber bundle 16.

The composite carbon fibers 18 may contact with each other either directly or via a cured product 22 of thermosetting resin containing high concentration CNTs 20a. As a result of increasing the density of CNT 20a, the CNTs 20a come closer to each other, allowing stronger bonding. The presence of such CNTs 20a in the stress relaxation portion 26 further enhances the effect of the stress relaxation portion 26.

In the reinforcement layer 14 formed as described above, it is also possible to reduce the variation of strength owing to the uniformity of the composite carbon fiber bundle 16. Winding the composite carbon fiber bundle 16 around the outer surface of the hollow liner 12 while applying a tensile load to the composite carbon fiber bundle 16 also contributes to increasing pressure resistance strength.

### 4. VARIANTS

The present invention will not be limited to the above described embodiment, and any appropriate alteration can be made within the spirit of the present invention.

The composite carbon fiber bundles 16 for forming the reinforcement layer 14 can be produced by using so-called Regular-Tow which is composed of ten to thirty thousand composite carbon fibers 18. The diameter of the carbon fiber 18a for constituting the composite carbon fiber bundle 16 can be appropriately set in a range of 5 to 10 μm.

When adhering the CNTs 20a on the surface of the carbon fibers 18a to obtain the composite carbon fiber bundle 16, the dispersion medium may be evaporated from the composite carbon fiber bundle by placing it on a hot plate, as well as using an evaporator.

The hollow liner 12 on whose outer surface the reinforcement layer 14 is formed may be formed of a different material provided that the hollow liner can contain gas and be sealed. A vessel composed of a different metal or resin may be used as the hollow liner 12 provided that the vessel has sealability.

When winding the composite carbon fiber bundle 16 around the outer surface of the hollow liner 12, lamination can be performed in any number of layers so as to obtain a desired layer thickness.

The reinforcement layer 14 can also be formed by a dry method. In this case, a tow-prepreg is used which is composed of, for example, the composite carbon fiber bundle 16 impregnated with a thermosetting resin. The thermosetting resin impregnated into the tow-prepreg may be dried or heated so as to be a semi-cured state. The tow-prepreg is wound around the outer surface of the hollow liner 12 while being subjected to a tensile load. The tow-prepreg can be wound around the outer surface of the hollow liner 12 with the thermosetting resin being melted. Alternatively, the thermosetting resin may be heated to be melted and cured in a later process.

As the thermosetting resin for fixing the composite carbon fiber bundle 16, epoxy resin as well as polyester resin, polyamide resin, etc. may be used.

In forming the reinforcement layer 14, it is also possible to place the hollow liner 12, around whose outer surface the composite carbon fiber bundle 16 impregnated with a thermosetting resin is wound, in an induction heating apparatus to cure the thermosetting resin by induction heating.

### 5. EXAMPLE

Although, hereinafter, the present invention will be described in detail with reference to an example, the present invention will not be limited to the following example.

<Production of Composite Carbon Fiber Bundle>

The composite carbon fiber bundle 16 to be used for manufacturing high pressure containers of an example was produced through the procedure shown in the above described manufacturing method. As the CNT 20a, MW-CNTs (Multi-walled Carbon Nanotubes) were used, which were grown to have a diameter of 10 to 15 nm and a length of not less than 100 μm on a silicon substrate by a thermal CVD method. To remove the catalyst residue of the CNT 20a, the CNT 20a was washed with a 3:1 mixed acid of sulfuric acid and nitric acid, and thereafter was filtered and dried. The cutting of the CNT 20a was performed by crushing it by an ultrasonic homogenizer in the dispersion medium until its length becomes 0.5 to 10 μm. MEK was used as the CNT dispersion medium to prepare a dispersion. The concentration of CNT in the dispersion was 0.01 wt %. This dispersion contained neither dispersion agent nor adhesive.

Next, as the carbon fiber bundle, T700SC-12000 (manufactured by Toray Industries, Inc.) was put into the dispersion while ultrasonic vibration of 130 kHz was applied to the dispersion. The carbon fiber bundle used herein contained 12000 carbon fibers 18a. The diameter of the carbon fiber 18a was about 7 μm, and the length thereof was about 100 m. The carbon fiber bundle was held in the dispersion for 10 seconds.

Thereafter, the carbon fiber bundle was taken out from the dispersion and was dried on a hot plate of about 80° C., to cause a plurality of CNTs 20a to adhere to the surface of each of the carbon fibers 18a constituting the carbon fiber bundle. As result of microscopic observation, it was confirmed that the plurality of CNTs 20a had formed a structure 20 having a network structure. Thus, the composite carbon fiber bundle 16 for use in forming the reinforcement layer 14 was obtained.

<Production of High Pressure Container>

The composite carbon fiber bundle 16 produced as described above was wound around the outer surface of the hollow liner 12 by the FW method to form the reinforcement layer 14. As the hollow liner 12, an aluminum liner (having an outer diameter of 60 mm and a length of 250 mm) was prepared.

The composite carbon fiber bundle 16 was wound around the outer surface of the hollow liner 12 while being impregnated with a thermosetting resin in a molten state by the wet method as described with reference to FIGS. 6 and 7. As the thermosetting resin, a bisphenol-based epoxy (JER828 manufactured by Mitsubishi Chemical Corporation) was used. The composite carbon fiber bundle 16 was wound around the outer surface of the hollow liner 12 by selecting the conditions of the FW apparatus such that the fraction of the composite carbon fiber bundle 16 in the reinforcement layer 14 was 60%.

The composite carbon fiber bundle 16 impregnated with the bisphenol-based epoxy resin was wound around the outer surface of the hollow liner 12 while applying a tensile load to the composite carbon fiber bundle 16 so as to obtain a predetermined layer thickness. For the winding of the composite carbon fiber bundle 16, helical winding and hoop winding were used in combination. Specifically, the composite carbon fiber bundle 16 was wound around the outer surface of the hollow liner 12 by a helical winding of a layer thickness of 0.49 mm, a hoop winding of a layer thickness of 0.49 mm, a helical winding of a layer thickness of 0.49 mm, and a both-end hoop winding of a layer thickness of 0.25 mm

The hollow liner 12 around whose outer surface the composite carbon fiber bundle 16 was wound was placed in a curing furnace, and heated at 100° C. for 1.5 hours, then at 160° C. for 4 hours, to cure the bisphenol-based epoxy resin and form the reinforcement layer 14, thereby producing a high-pressure container 10 of the example.

Further, a high pressure container of a comparative example was produced in the same fashion excepting that the above described T700SC-12000 (manufactured by Toray Industries, Inc.) was used in a non-compounded state, in which there was no CNT adhered, to form the reinforcement layer.

<Internal Pressure Breakage Test of High Pressure Container>

An internal pressure breakage test was conducted on the high pressure containers of the example and the comparative example to investigate pressure resistance.

In performing the internal pressure breakage test, one of the mouthpieces of the high pressure container was sealed, and water was contained in the high pressure container as pressure medium. The other mouthpiece was connected to a pump via a high pressure piping, and pressure was applied to the inside of the high pressure container. Strain gauges (two sheets/body) were bonded to the surface of the high pressure container, and breakage test was performed by increasing the internal pressure while observing the state of strain.

It is possible to confirm occurrence of a crack in the hollow liner from a measurement result of strain by the strain gauge. The breakage test was ended when a crack occurred in the hollow liner due to internal pressure. The pressure at which a crack occurred was supposed to be a burst pressure of the high pressure container. Since the burst pressure reflects the pressure resistance strength, the larger the burst pressure is, the more preferable it is.

While the burst pressure of the high pressure container of the comparative example was 59.5 MPa, the burst pressure of the high pressure container of the example was 67.3 MPa. In the high pressure container of the example, the reinforcement layer covering the outer surface of the hollow liner was formed by using a composite carbon fiber bundle containing carbon fibers to whose surface CNTs were adhered. It is seen that as a result of the reinforcement layer being strengthened by CNTs, the pressure resistance strength has increased by about 13%.

<Cross Sectional Observation of Reinforcement Layer>

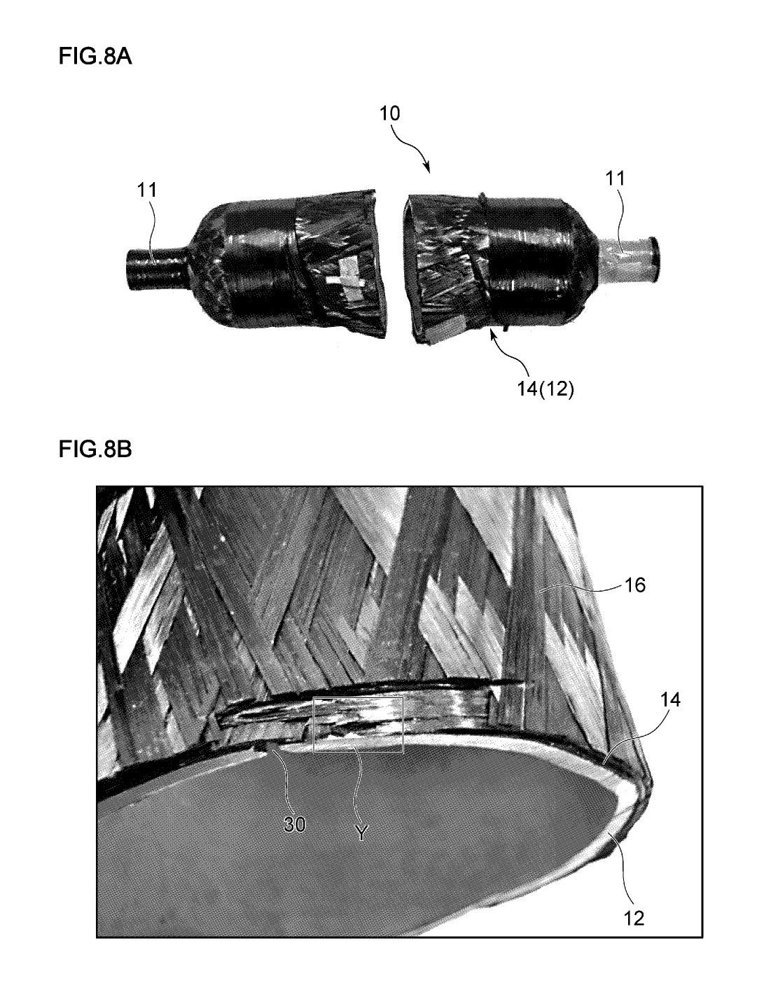

The cross section of the reinforcement layer 14 after the internal pressure breakage test was observed for the high pressure container 10 of the example. The high pressure container 10 after the internal pressure breakage test was cut along the diameter of the cylinder portion as shown in FIG. 8A. As shown in FIG. 8B, the reinforcement layer 14 was formed by winding the composite carbon fiber bundle 16 around the outer surface of the hollow liner 12. In the vicinity of a cut portion of the high pressure container 10, a crack 30 had occurred in a portion of the hollow liner 12 as shown in FIG. 8B.

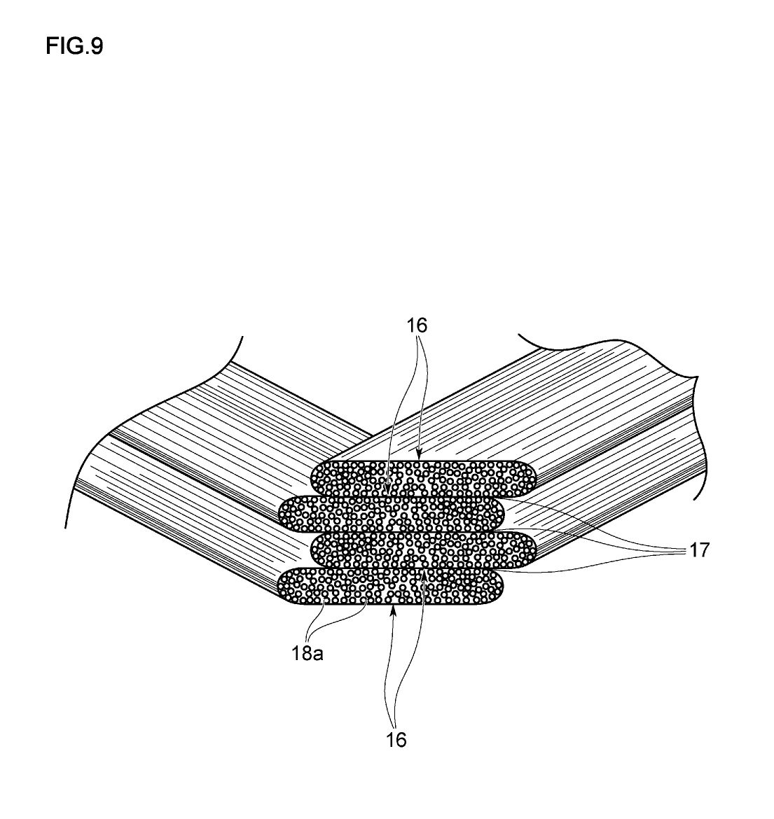

A portion of the reinforcement layer 14 was taken out from a region Y in FIG. 8B, and the obtained cut piece was subjected to microscopic observation of the state of cross section. As shown schematically in FIG. 9, the cut piece of the reinforcement layer 14 contained a plurality of composite carbon fiber bundles 16 which were laminated via the interface 17. Each of the composite carbon fiber bundles 16 contained a plurality of carbon fibers 18a. The two composite carbon fiber bundles 16 which were in contact with the interface 17 extended longitudinally in respective directions different from each other.

In producing a reinforcement layer sample for microscopic observation, the cut piece was fixed with an epoxy-based adhesive to prevent the laminated, a plurality of composite carbon fiber bundles 16 from being disintegrated. Further, a plane in which the laminated state of the composite carbon fiber bundle 16 was exposed was polished and interposed with transparent film to prepare a reinforcement layer sample for microscopic observation.

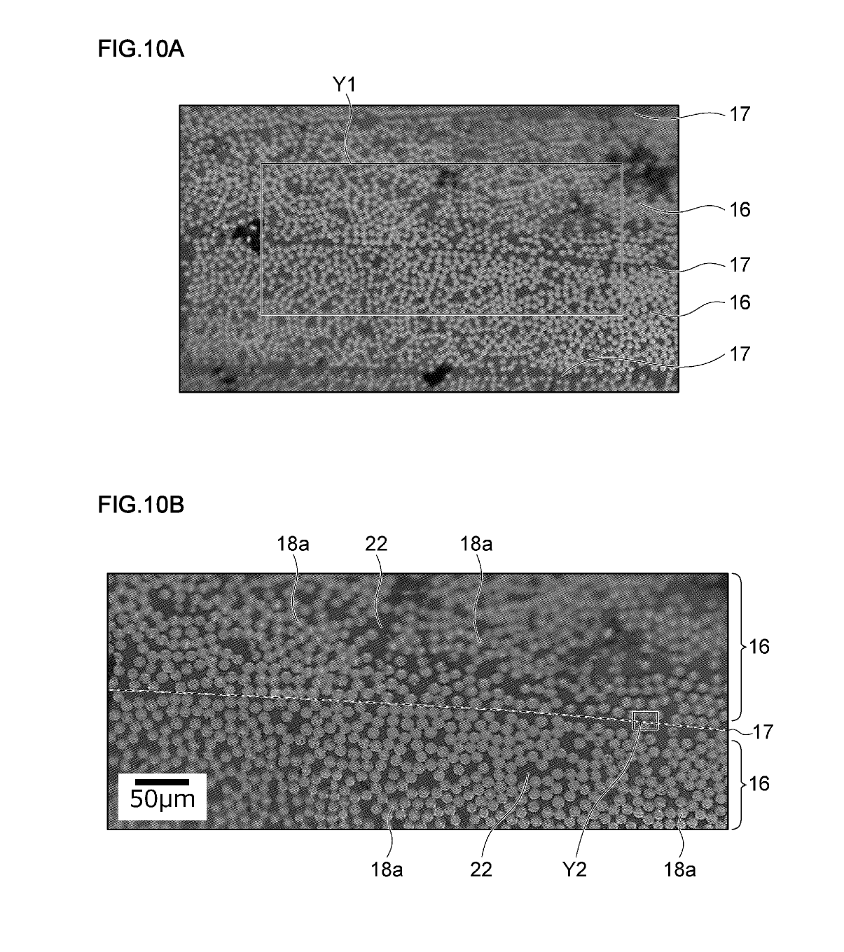

A microscopic photograph of the reinforcement layer sample is shown in FIG. 10. As shown in FIG. 10A, the reinforcement layer sample contained a plurality of composite carbon fiber bundles 16 laminated via the interface 17.

An enlarged image of a region Y1 in FIG. 10A is shown in FIG. 10B. As shown in the region Y1, the composite carbon fiber bundles 16 were laminated with each other via the interface 17. Each composite carbon fiber bundle 16 contained a plurality of carbon fibers 18a fixed with a cured product 22 of thermosetting resin. In a region Y2 in FIG. 10B, it is shown that carbon fibers 18a in respective composite carbon fiber bundles 16 were in contact with each other at the interface 17.

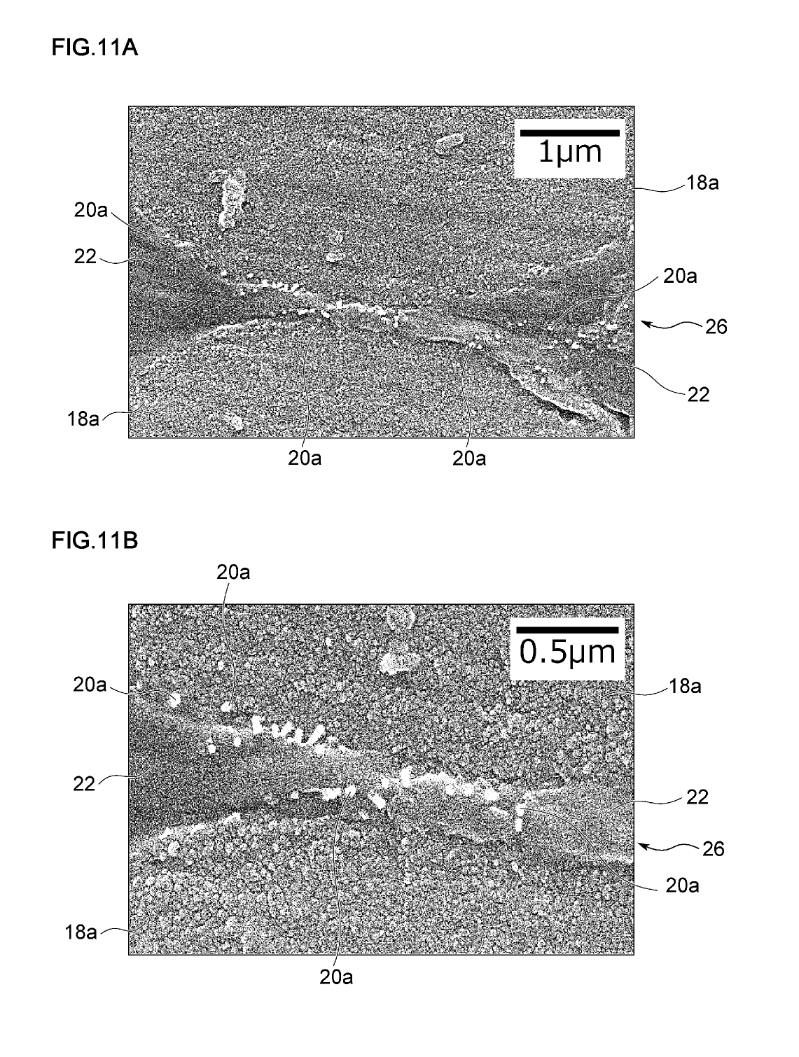

An SEM image of the region Y2 in FIG. 10B is shown in FIGS. 11A and 11B. From these figures, it was confirmed that the carbon fibers 18a to whose surface a plurality of CNTs 20a were adhered were in contact with each other via the cured product 22 of thermosetting resin. Moreover, it was confirmed that a plurality of CNTs 20a were contained in the cured product 22 of thermosetting resin which was present between the carbon fibers 18a. The cured product 22 of thermosetting resin containing a plurality of CNTs 20a constituted a stress relaxation portion 26.

Since CNTs 20a were present in the reinforcement layer 14, it was possible to increase the pressure resistance strength of the high pressure container 10 of the example.

<Comparison with CFRP Test Specimen>

For reference purposes, a tensile test by a CFRP test specimen was conducted on the composite carbon fiber bundle 16 used for the high pressure container 10 of the example and non-compounded carbon fiber bundle used for the high pressure container of the comparative example. The CFRP test specimen (of a width of about 15 mm, a length of parallel part of about 150 mm, and a thickness of about 0.8 mm) was produced without applying a tensile load thereto. Specifically, the composite carbon fiber bundle 16 was impregnated with a similar bisphenol-base epoxy resin as described above, and was cured at the similar conditions as described above to produce a test specimen “a”. Further, non-compounded carbon fiber bundle was used to produce a test specimen “b” by the similar method.

The tensile strength of the test specimens “a” and “b” was measured by a tensile test machine. Although the tensile strength of the test specimen “a” was higher than that of the test specimen “b”, the difference between them was about 6%. Compared with the difference (13%) of the pressure resistance strength between the above described example and comparative example, the difference of the tensile strength of the CFRP test specimen was small.

Since winding the composite carbon fiber bundle 16 around the outer surface of the hollow liner 12 while applying a tensile load to the composite carbon fiber bundle will cause the carbon fiber 18a to be oriented in a fixed direction, as well as to increase the density of CNT 20a between the carbon fibers 18a, it is inferred that the effect of the composite carbon fiber bundle 16 is fully exerted.

### REFERENCE SIGNS LIST

10 High pressure container

12 Hollow liner

14 Reinforcement layer

16 Composite carbon fiber bundle

18a Carbon fiber

20 Structure

20a Carbon nanotube (CNT)

22 Cured product of thermosetting resin

1. A high pressure container, comprising:
a hollow liner capable of being sealed; and
a reinforcement layer covering an outer surface of the hollow liner, wherein
the reinforcement layer includes composite carbon fiber bundles laminated in multiple layers, and the composite carbon fiber bundles are wound around the outer surface of the hollow liner and fixed by a cured product of thermosetting resin, and
the reinforcement layer contains a stress relaxation portion which includes the cured product of thermosetting resin and a plurality of carbon nanotubes between a carbon fiber contained in one composite carbon fiber bundle and a carbon fiber contained in other of the composite carbon fiber bundles.

2. The high pressure container according to claim 1, wherein
some of the plurality of carbon nanotubes are adhered to the carbon fiber.

3. The high pressure container according to claim 2, wherein
some of the plurality of carbon nanotubes are directly connected with each other, thereby forming a structure having a network structure.

4. The high pressure container according to claim 1, wherein
the composite carbon fiber bundle contains ten thousand to thirty thousand of the carbon fibers.

5. A method for manufacturing a high pressure container having a reinforcement layer on an outer surface of a hollow liner capable of being sealed, the method comprising steps of:
winding a composite carbon fiber bundle impregnated with a thermosetting resin around the outer surface of the hollow liner while applying a tensile load to the composite carbon fiber bundle; and
forming the reinforcement layer by curing the thermosetting resin, wherein
the composite carbon fiber bundle contains a plurality of continuous carbon fibers, on each of whose surfaces a structure containing a plurality of carbon nanotubes is formed, and the structure is directly adhered to a surface of each of the plurality of continuous carbon fibers.

6. The method for manufacturing a high pressure container according to claim 5, wherein
the structure is formed on each of the surfaces of the plurality of continuous carbon fibers by immersing a carbon fiber bundle containing the plurality of continuous carbon fibers into a carbon nanotube-isolated dispersion containing a plurality of carbon nanotubes isolated and dispersed, and applying ultrasonic vibration of a frequency more than 40 kHz and not more than 180 kHz to the carbon nanotube-isolated dispersion.

7. The method for manufacturing a high pressure container according to claim 5, wherein
the composite carbon fiber bundle contains ten thousand to thirty thousand of the carbon fibers.

8. The method for manufacturing a high pressure container according to claim 6, wherein
the frequency of the ultrasonic vibration is not less than 100 kHz.
